(19) United States
(12) Patent Application Publication
(10) Pub. No.: US 2004/0170202 A1
(43) Pub. Date: Sep. 2, 2004

(54) Laser light generator, line beam optical system, laser marking apparatus, and miter saw

(76) Inventor: Takashi Nishimura, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/785,942

(22) Filed: Feb. 26, 2004

(30) Foreign Application Priority Data
Feb. 28, 2003 (JP) P2003-054840

(51) Int. Cl. H01S 3/10; H01S 3/00

(52) U.S. Cl. 372/38.03; 372/25

(57) ABSTRACT

By operating a mode switch, a user switches a laser light source module into one of five operation modes: a difficult detection/normal mode, a difficult detection/energy-saving mode, an easy detection/normal mode, an easy detection/energy-saving mode, and a photodetector mode. A ROM stores therein five combinations of data in one to one correspondence with the five operation modes. Each data combination includes data of drive frequency and data of ON duty ratio. When the user selects his/her desired mode, a CPU reads, from the ROM, one data combination of drive frequency and ON duty ratio that corresponds to the user's selected mode. The CPU applies the base of the transistor with a pulse drive voltage, whose repetition period and whose pulse width correspond to the read drive frequency and ON duty ratio. A laser diode oscillates in pulses with the drive frequency and ON duty ratio.

### BACKGROUND OF THE INVENTION

1. Field of the Invention

The present invention relates to a laser light generator, a line beam optical system, a laser marking apparatus, and a miter saw.

2. Description of Related Art

Laser pointers and laser marking devices for outputting laser light used for marking are well known in the art. Examples of these devices have been proposed in Japanese unexamined patent application publications Nos. HEI-3-200994, HEI-7-94815, and HEI-11-295070.

Since these devices employ laser light as the marking light, the intensity of the light must be kept below a prescribed value (such as 1 mW) in order to ensure safety to the human eye. Therefore, the laser marks can be difficult to discern or completely undetectable when the laser light is irradiated in bright areas. This is particularly true for laser marking devices that spread dot laser beams into line beams. In this case, the light intensity per unit area of the line beam is less than the intensity of the dot beam. Accordingly, the line beam is more difficult to detect than the dot beam. If the line beam outputted from a laser marking apparatus is difficult to discern, the user may have difficulty drawing marking lines with accuracy.

The laser pointer disclosed in Japanese unexamined patent application publication No. HEI-3-200994 can be switched between a mode for outputting a continuous light and another mode for outputting a pulsating light. The frequency and pulse width of the pulsating light may also be adjusted.

The laser pointer disclosed in Japanese unexamined patent application publication No. HEI-7-94815 can control a semiconductor laser to flash at a frequency of 8-16 Hz, making the laser light more easily detectable by the human eye.

The laser marking device disclosed in Japanese unexamined patent application publication No. HEI-11-295070 can switch a semiconductor laser between a pulsed state and a continuously state. The pulse cycle and the ON duty ratio of the semiconductor laser may also be varied.

A miter saw, such as that disclosed in Japanese unexamined patent application publication No. 2001-158003, is also capable of using laser light for marking. In this miter saw, a laser oscillator is disposed on the cutting blade and irradiates a laser light to indicate the cutting position of a material to be cut. The laser oscillator is provided with a laser light source, a convex lens, and a columnar lens for generating a line beam.

### SUMMARY OF THE INVENTION

Each of the laser pointer, laser marking apparatus, and miter saw is employed in a variety of operating environments. In some cases, it is necessary to cut down on power consumption and in other cases it is not. However, conventional laser pointers, laser marking apparatuses, and miter saws are not capable of meeting the demands for reduced power consumption and improved visibility of the marking light and are therefore not optimal for use in certain conditions.

In view of the foregoing, it is an object of the present invention to provide a laser light generator, a line beam optical system, a laser marking apparatus, and a miter saw capable of optimizing power consumption and marking visibility in correspondence with a variety of operating conditions.

In order to attain the above and other objects, the present invention provides a laser light generator including: a semiconductor laser; a selecting unit; and a controlling unit. The semiconductor laser emits laser light The switching element switches the semiconductor laser on and off. The selecting unit selects one of a plurality of operation modes. The controlling unit controls the switching element to drive the semiconductor laser based on a combination of a drive frequency and an ON duty ratio that corresponds to the operation mode selected by the selecting unit.

According to another aspect, the present invention provides a line beam optical system including: a laser light generator; a collimator lens; and a rod lens. The laser light generator includes: a semiconductor laser; a switching element; a selecting unit; and a controlling unit. The semiconductor laser emits laser light. The switching element switches the semiconductor laser on and off. The selecting unit selects one of a plurality of operation modes. The controlling unit controls the switching element to drive the semiconductor laser based on a combination of a drive frequency and an ON duty ratio that corresponds to the operation mode selected by the selecting unit. The collimator lens converts the laser beam emitted from the laser light generator. The rod lens converts the collimated light into a line beam.

According to another aspect, the present invention provides a laser marking apparatus including: a line beam optical system; and a support mechanism that supports the line beam optical system. The line beam optical system includes: a laser light generator; a collimator lens; and a rod lens. The laser light generator includes a semiconductor laser; a switching element; a selecting unit; and a controlling unit. The semiconductor laser emits laser light. The switching element switches the semiconductor laser on and off. The selecting unit selects one of a plurality of operation modes. The controlling unit controls the switching element to drive the semiconductor laser based on a combination of a drive frequency and an ON duty ratio that corresponds to the operation mode selected by the selecting unit. The collimator lens converts the laser beam emitted from the laser light generator. The rod lens converts the collimated light into a line beam.

According to another aspect, the present invention provides a miter saw including; a base; a support unit; a circular saw cutting unit; and a laser light generator. A material to be cut is placed on the base. The support unit is supported on the base. The circular saw cutting unit is pivotally supported by the support unit. The laser light generator is disposed on either one of the support unit and the circular saw cutting unit, and irradiates laser light on the material to be cut. The laser light generator includes: a semiconductor laser; a switching element; a selecting unit; and a controlling unit. The semiconductor laser emits laser light. The switching element switches the semiconductor laser on and off. The selecting unit selects one of a plurality of operation modes. The controlling unit controls the switching element to drive the semiconductor laser based on a combination of a drive frequency and an ON duty ratio that corresponds to the operation mode selected by the selecting unit.

According to another aspect, the present invention provides a miter saw including: a base; a support unit; a circular saw cutting unit; and a laser light generator. A material to be cut is placed the base. The support-unit is supported on the base. The circular saw cutting unit is pivotally supported by the support unit. The laser light generator is disposed on either one of the support unit and the circular saw cutting unit, and irradiates laser light on the material to be cut. The laser light generator includes: a semiconductor laser; a switching element; a selecting unit; and a controlling unit. The semiconductor laser emits laser light. The switching element switches the semiconductor laser on and off. The selecting unit selects one of a flashing mode and a continuous mode. The controlling unit controls the switching element to drive the semiconductor laser at a prescribed frequency when the flashing mode is selected by the selecting unit, and controls the switching element to drive the semiconductor laser to emit continuous light when the continuous mode is selected by the selecting unit.

### BRIEF DESCRIPTION OF THE DRAWINGS

The above and other objects, features and advantages of the invention will become more apparent from reading the following description of the preferred embodiments taken in connection with the accompanying drawings in which:

FIG. 1 is a side view showing the general construction of a laser marking apparatus according to a first embodiment of the present invention;

FIG. 2 is an explanatory diagram showing a line beam optical system that is mounted on the laser marking apparatus of FIG. 1;

FIG. 3 is a schematic diagram showing a pulse oscillating circuit mounted in the line beam optical system of FIG. 2;

FIG. 4(a) is a flowchart showing the laser oscillating operation executed by the pulse oscillating circuit of FIG. 3;

FIG. 4(b) is a table showing experimental results for the degree of visibility relative to a plurality of combinations of drive frequency and ON duty ratio;

FIG. 5 is an explanatory side view of a miter saw according to a second embodiment of the present invention;

FIG. 6 is a perspective view of the miter saw of FIG. 5, showing a workpiece setting state on the base of the miter saw;

FIG. 7 is a perspective view of the miter saw of FIG. 5, with no workpiece set on the base of the miter saw;

FIG. 8 is a rear view of the miter saw of FIG. 5; and

FIG. 9 is a flowchart showing the laser oscillating operation according to a variation of the second embodiment.

### DETAILED DESCRIPTION OF THE PREFERRED EMBODIMENTS

A laser light generator, a line beam optical system, a laser marking apparatus, and a miter saw according to preferred embodiments of the present invention will be described while referring to the accompanying drawings wherein like parts and components are designated by the same reference numerals to avoid duplicating description.

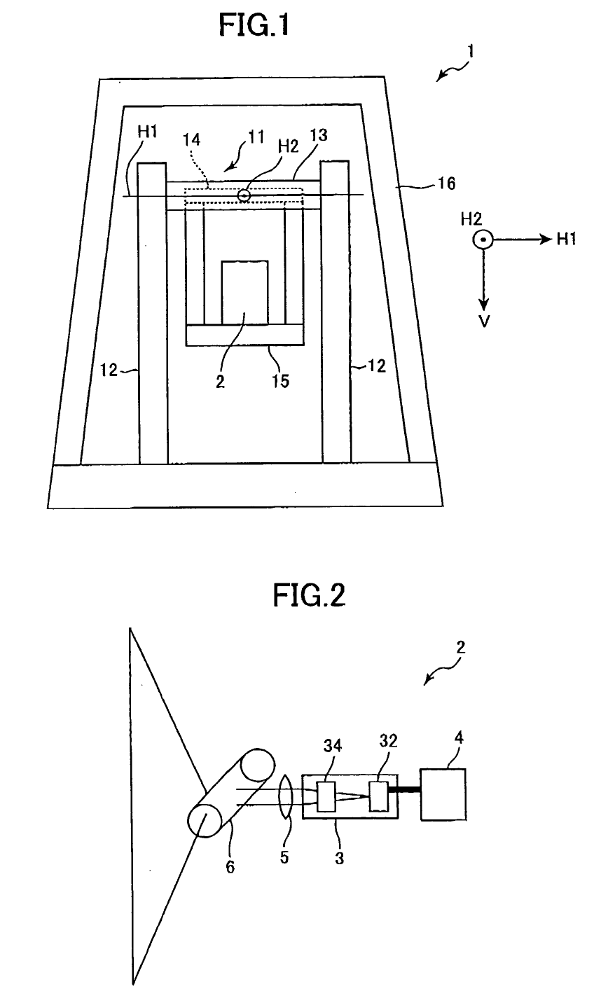

A laser marking apparatus according to a first embodiment of the present invention will be described with reference to FIGS. 1-4(b).

FIG. 1 shows the laser marking apparatus 1 of the first embodiment.

Specifically, the laser marking apparatus 1 includes: a line-beam generating optical system 2 according to the present embodiment, a support mechanism 11 for keeping the line-beam generating optical system 2 level or horizontal, and a case 16 covering the line-beam generating optical system 2 and support mechanism 11.

The support mechanism 11 employs a gimbal mechanism well known in the art. The support mechanism 11 includes a support frame 12, a large ring 13, a small ring 14, and a mounting platform 15. The large ring 13 is capable of pivoting around one horizontal H1-axis in relation to the support frame 12 by means of bearings (not shown). The small ring 14 is capable of pivoting around another horizontal H2-axis (perpendicular to the H1-axis and therefore perpendicular to the surface of the drawing) in relation to the large ring 13 by means of other bearings (not shown). The mounting platform 15 is fixed to the small ring 14 and supports the line-beam generating optical system 2. With this construction, the mounting platform 15, on which the line-beam generating optical system 2 is mounted, can be maintained level or horizontal.

Next, the line beam optical system 2 will be described with reference to FIG. 2.

The line beam optical system 2 includes a laser light source module 3, a pulse oscillating circuit 4, a collimator lens 5, and a rod lens 6.

The laser light source module 3 in the preferred embodiment generates a green laser light. More specifically, the laser light source module 3 includes a laser diode 32 and a wavelength converting optical element 34. In the preferred embodiment, the laser diode 32 is a basic laser diode that generates a laser light having a wavelength of 808 nm. The wavelength converting optical element 34 is an SHG crystal that converts the 808-nm wavelength light to a 532-nm wavelength, green light,

The collimator lens 5 serves to generate parallel light rays by collimating light emitted from the laser light source module 3. The rod lens 6 is provided on the optical axis of the collimator lens 5 and serves to convert collimated light received from the collimator lens 5 into a line beam.

The pulse oscillating circuit 4 is connected to the laser light source module 3 and drives the laser diode 32 with a pulse drive signal, causing the laser diode 32 to oscillate in pulses. The pulse oscillating circuit 4 controls the frequency and ON duty ratio of the pulse oscillations. The pulsating light emitted from the laser light source module 3 is converted by the collimator lens 5 and rod lens 6 into a flashing line beam.

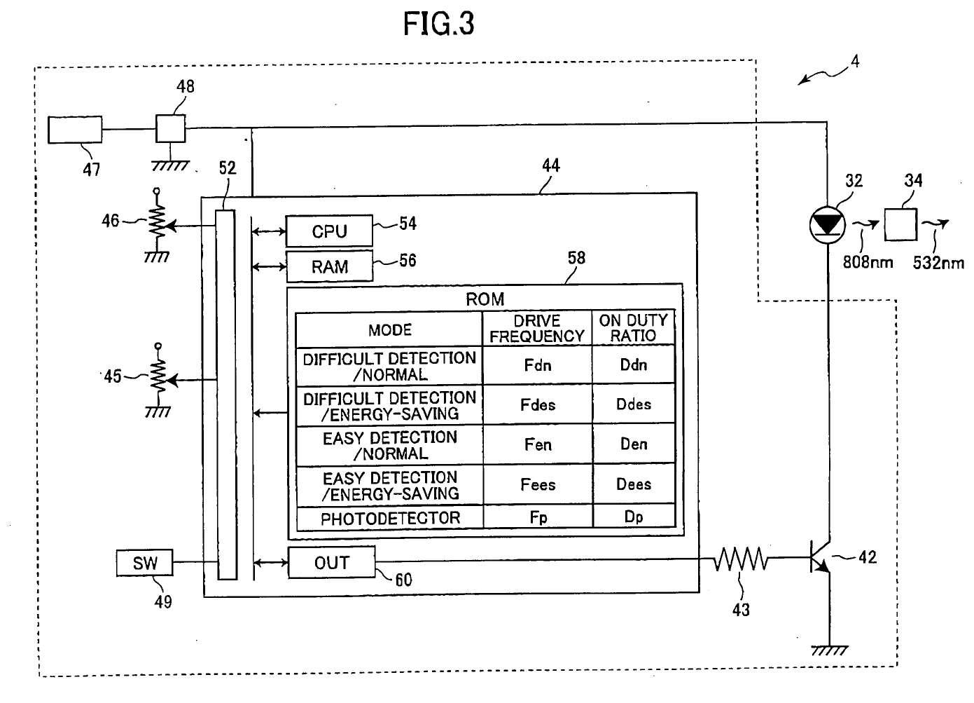

FIG. 3 shows the general structure of the pulse oscillating circuit 4.

The pulse oscillating circuit 4 includes: a microcomputer 44, a power source 47, a regulator 48, a mode switch 49, variable resistors 45 and 46, a transistor 42, and a resistor 43. The microcomputer 44 includes: an input port 52, a CPU 54, a RAM 56, a ROM 58, and an output port 60. The input port 52, CPU 54, RAM 56, ROM 58, and output port 60 are connected to one another via a bus.

The power source 47 is connected to the microcomputer 44 and the laser diode 32 via the regulator 48. The regulator 48 ensures that the voltage supply from the power source 47 to the microcomputer 44 and the laser diode 32 remains at a prescribed voltage.

The output port 60 is connected to a base of the transistor 42 via the resistor 43. The transistor 42 is a switching element that functions to switch the laser diode 32 on and off. The microcomputer 44 supplies a pulse drive current having some drive frequency F and some ON duty ratio D via the output port 60 to the base of the transistor 42 via the resistor 43. The transistor 42 is turned on and off according to the drive frequency F and the ON duty ratio D, thereby applying a pulse current having the drive frequency F and the ON duty ratio D to the laser diode 32. As a result, the laser diode 32 oscillates in a pulse having the drive frequency F and the ON duty ratio D.

If F(Hz) is the pulse oscillating frequency, T(s) is the time required to perform one cycle of the pulse oscillation, and P and Q are the times during the ON interval and OFF interval, respectively, during one cycle, then the following equations are satisfied:

T=P+Q (1)

F=1/T (2)

The ON duty ratio D is the ratio of the ON interval P to the cycle T and is defined as a value satisfying the following equation:

P=D·T=D·(1/F) (3)

The mode switch 49 is connected to the input port 52. The mode switch 49 is operated by a user. By operating the mode switch 49, the user can switch the laser light source module 3 into one of five predetermined operation modes: a difficult detection/normal mode, a difficult detection/energy-saving mode, an easy detection/normal mode, an easy detection/energy-saving mode, and a photodetector mode. Hereinafter, the easy detection/normal mode and easy detection/energy-saving mode will be collectively referred to as the easy detection modes, and the difficult detection/normal mode and the difficult detection/energy-saving mode will be collectively referred to as the difficult detection modes.

When the laser marking apparatus 1 is used in a bright location, the line beam is affected by ambient light and may be difficult to pick up visually. On the other hand, while the line beam may be easy to distinguish visually when the laser marking apparatus 1 is used in a dark location or the like, flicker in the line beam may be disconcerting to the senses. Therefore, when the laser marking apparatus 1 of the preferred embodiment is used in an environment favorable for detecting the line bean visually, the user selects the easy detection/normal mode when it is not necessary to conserve power and selects the easy detection/energy-saving mode when it is preferable to conserve power. When the laser marking apparatus 1 is used in an environment not favorable for detecting the line beam, the user selects the difficult detection/normal mode when it is not necessary to conserve power and selects the difficult detection/energy-saving mode when it is preferable to conserve power. The user selects the photodetector mode when using a photodetector to find the location of the line beam.

For example, the photodetector may include a photocell for detecting light, an amplifier for amplifying the output of the photocell, and a comparator for judging whether the level of light detected by the photocell and amplified by the amplifier exceeds a predetermined threshold, thereby determining whether the photodetector detects the line beam emitted from the line beam optical system 2. An example of the photodetector is described in U.S. Pat. No. 5,621,531.

Or, the photodetector may include a differential circuit for extracting pulsating light by cutting out fixed light. With this circuit, the photodetector can detect a pulsating line beam with higher accuracy. An example of this type of photodetector is described in Japanese unexamined patent application publication No. HEI-11-295070.

The ROM 58 stores therein five combinations of data in one to one correspondence with the five operation modes described above. Each data combination includes data of a drive frequency and data of an ON duty ratio.

More specifically, the ROM 58 stores data of drive frequency F_{dn} (difficult detection/normal drive frequency F_{dn}) and ON duty ratio D_{dn} (difficult detection/normal ON duty ratio D_{dn}) in correspondence with the difficult detection/normal mode. The drive frequency F_{dn} and the ON duty ratio D_{dn} are set to a combination of values that is capable of making pulsed light from the laser light source module 3 appear brighter through the Broca-Sulzer effect. In the preferred embodiment, the drive frequency F_{dn} has a value within a drive-frequency-range RF_{d} (difficult-detection/drive-frequency-range RF_{d}), and the ON duty ratio D_{dn} has a value within an ON-duty-ratio-range RD_{dn} (difficult detection/normal ON-duty-ratio-range RD_{dn}), The drive-frequency-range RF_{d} is defined as a range higher than or equal to 4 Hz and lower than or equal to 100 Hz. The ON-duty-ratio-range RD_{dn} is defined as a range greater than or equal to 35% and smaller than or equal to 70%.

The ROM 58 also stores data of drive frequency F_{des} (difficult detection/energy-saving drive frequency F_{des}) and ON duty ratio D_{des} (difficult detection/energy-saving ON duty ratio D_{des}) in correspondence with the difficult detection/energy-saving mode. The drive frequency F_{des} and the ON duty ratio D_{des} are set to a combination of values that is capable of decreasing power consumption while making pulsed light from the laser light source module 3 appear brighter through the Broca-Sulzer effect. In the preferred embodiment, the drive frequency F_{des} has a value within the drive-frequency-range RF_{d}, and the ON duty ratio D_{des} has a value within an ON-duty-ratio-range RD_{des} (difficult detection/energy-saving ON-duty-ratio-range RD_{des}). The ON-duty-ratio-range RD_{des} is defined as a range greater than or equal to 20% and smaller than or equal to 35%.

The ROM 58 also stores data of drive frequency Fₑₙ (easy detection/normal drive frequency Fₑₙ) and ON duty ratio Dₑₙ (easy detection/normal ON duty ratio Dₑₙ) in correspondence with the easy detection/normal mode. The drive frequency Fₑₙ and the ON duty ratio Dₑₙ are set to a combination of values that can prevent the pulsed light from the laser light source module 3 from appearing to be flashing, In the preferred embodiment, the drive frequency Fₑₙ has a value within a drive-frequency-range RFₑ (easy detection/drive-frequency-range RFₑ), and the ON duty ratio Dₑₙ has a value within an ON-duty-ratio-range RDₑₙ (easy-detection/normal ON-duty-ratio-range RDₑₙ). The drive-frequency-range RFₑ is defined as a range higher than or equal to 80 Hz and lower than or equal to 10 KHz. The ON-duty-ratio-range RDₑₙ is defined as a range greater than or equal to 50% and smaller than 100%.

The ROM 58 also stores data of drive frequency Fₑₑₛ (easy detection/energy-saving drive frequency Fₑₑₛ) and ON duty ratio Dₑₑₛ (easy detection/energy-saving ON duty ratio Dₑₑₛ) in correspondence with the easy detection/energy-saving mode, The drive frequency Fₑₑₛ and the ON duty ratio Dₑₑₛ are set to a combination of values that can reduce power consumption while preventing the pulsed light from the laser light source module 3 from appearing to be flashing. In the preferred embodiment, the drive frequency Fₑₑₛ has a value within the drive-frequency-range RFₑ, and the ON duty ratio Dₑₑₛ has a value within an ON-duty-ratio-range RDₑₑₛ (easy detection/energy-saving ON-duty-ratio-range RDₑₑₛ). The ON-duty-ratio-range RDₑₑₛ is defined as a range greater than or equal to 20% and smaller than or equal to 50%.

The ROM 58 also stores data of drive frequency Fₚ (photodetector-mode drive frequency Fₚ) and data of ON duty ratio Dₚ (photodetector-mode ON duty ratio Dₚ) in correspondence with the photodetector mode. The drive frequency Fₚ and the ON duty ratio Dₚ are set to a combination of values that can enable the photodetector to detect a pulsating line beam with good accuracy. In the preferred embodiment, the drive frequency Fₚ has a value within a drive-frequency-range RFₚ (photodetector-mode drive-frequency-range RFₚ), and the ON duty ratio Dₚ has a value within an ON-duty-ratio-range RDₚ (photodetector-mode ON-duty-ratio-range RDₚ) The drive-frequency-range RFₚ is defined as a range higher than or equal to 1 KHz and lower than or equal to 10 KHz. The ON-duty-ratio-range RDₚ is defined as a range greater than or equal to 30% and smaller than 100%.

Next, a method for setting the five combinations of the drive frequency and duty ratio (F_{dn}, D_{dn}), (F_{des}, D_{des}), (Fₑₙ, Dₑₙ), (Fₑₑₛ, Dₑₑₛ) and (Fₚ, Dₚ) will be described.

During the manufacturing stage prior to shipping the laser marking apparatus 1 from the factory, the manufacturer of the laser marking apparatus 1 subjects the laser light source module 3 mounted in the laser marking apparatus 1 to drive tests and sets the above data combinations.

During the drive tests, the manufacturer repeatedly drives the laser light source module 3 in pulses, while varying the drive frequency and the ON duty ratio within the drive-frequency-range RF_{d} and the ON-duty-ratio-range RD_{dn}, respectively. The manufacturer sets the drive frequency F_{dn} and the ON duty ratio D_{dn} to the drive frequency value and ON duty ratio value combination, for which the line beam appears to be the brightest.

The manufacturer further repeatedly drives the laser light source module 3 in pulses, while varying the drive frequency and the ON duty ratio within the drive-frequency-range RF_{d} and ON-duty-ratio-range RD_{des}, respectively. The manufacturer sets the drive frequency F_{des} and the ON duty ratio D_{des} to the drive frequency value and ON duty ratio value combination, for which the line beam appears to be the brightest.

The manufacturer further repeatedly drives the laser light source module 3 in pulses, while varying the drive frequency and the ON duty ratio within the drive-frequency-range RFₑ and ON-duty-ratio-range RDₑₙ, respectively. The manufacturer sets the drive frequency Fₑₙ and the ON duty ratio Dₑₙ to the drive frequency value and ON duty ratio value combination for which flicker of the line beam is the least noticeable.

The manufacturer further repeatedly drives the laser light source module 3 in pulses, while varying the drive frequency and the ON duty ratio within the drive-frequency-range RFₑ and ON-duty-ratio-range RDₑₑₛ, respectively. The manufacturer sets the drive frequency Fₑₑₛ and the ON duty ratio Dₑₑₛ to the drive frequency value and ON duty ratio value combination for which flicker of the line beam is the least noticeable.

The manufacturer further repeatedly drives the laser light source module 3 in pulses, while varying the drive frequency and the ON duty ratio within the drive-frequency-range RFₚ and ON-duty-ratio-range RDₚ, respectively. The manufacturer sets the drive frequency Fₚ and the ON duty ratio Dₚ to the drive frequency value and ON duty ratio value combination for which the photodetector is capable of detecting the line beam with the greatest accuracy.

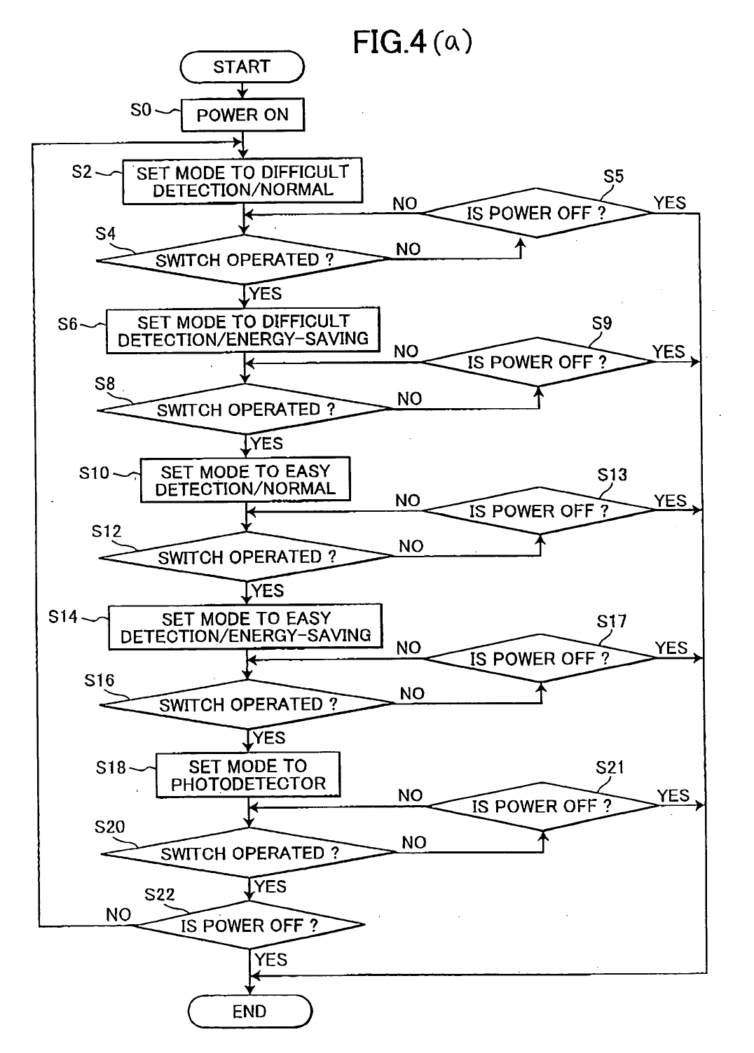

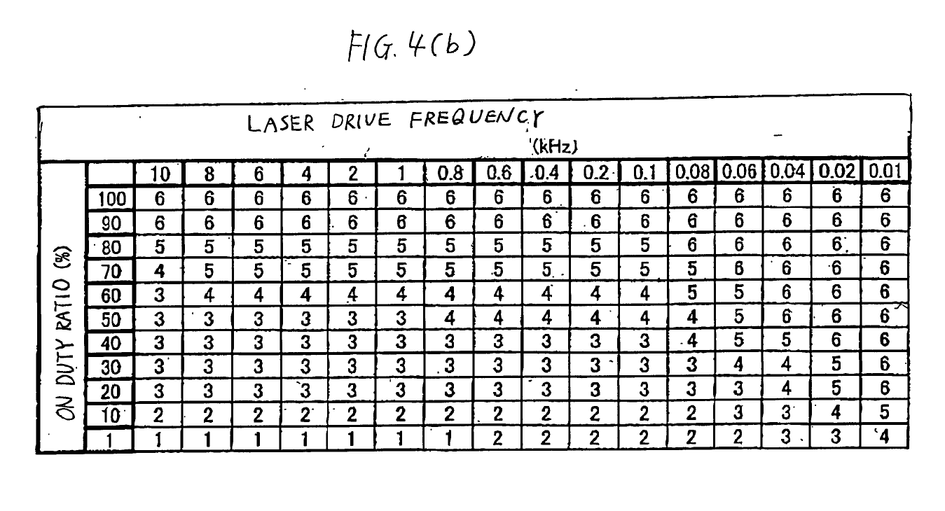

The ROM 58 also stores a laser oscillation program that will be described with reference to FIG. 4(a). By executing this laser oscillation program, the CPU 54 can prompt the user to select a desired operation mode, read one combination of the drive frequency and ON duty ratio that corresponds to the user's selected operation mode from the ROM 58, control the laser diode 32 to pulsate based on the combination of the drive frequency and the ON duty ratio.

The RAM 56 temporarily stores data such as the results of calculations performed while the CPU 54 executes the laser oscillation program.

The variable resistors 45 and 46 are connected to the input port 52. The user can fine-tune the ON duty ratio of the laser diode 32 by adjusting the resistance value in the variable resistor 45 and can fine-tune the drive frequency of the laser diode 32 by adjusting the resistance value of the variable resistor 46.

Next the laser oscillating operation will be described with reference to FIG. 4(a).

When the user turns ON the power source 47 in S0, the CPU 54 initializes the operation mode to the difficult detection/normal mode in S2. In S2, the CPU 54 reads, from the ROM 58, data combination of drive frequency F_{dn} and ON duty ratio D_{dn} that corresponds to the difficult detection/normal mode. The CPU 54 applies the base of the transistor 42 with a pulse drive voltage, whose repetition period and whose pulse width correspond to the drive frequency F_{dn} and ON duty ratio D_{dn}, respectively. As a result, the laser diode 32 oscillates in pulses with the drive frequency F_{dn} and ON duty ratio D_{dn}. The CPU 54 judges in S4 whether or not the user manipulates the mode switch 49 to change the position of the mode switch 49. While the user does not manipulate the mode switch 49 (no in S4), the CPU 54 further judges in S5 whether or not the user turns off the power source 47. While the user does not turn off the power (no in S5), the program returns to S4. When the user turns off the power (yes in S5), the laser oscillating operation ends. In this way, the CPU 54 continues driving the laser diode 32 in the difficult detection/normal mode until the user changes the position of the mode switch 49 or turns off the power.

When the user manipulates the mode switch 49 to change the position of the mode switch 49 (S4: YES), then in S6, the CPU 54 sets the operation mode to the difficult detection/energy-saving mode. In S6, the CPU 54 reads, from the ROM 58, data combination of drive frequency F_{des} and ON duty ratio D_{des} that corresponds to the difficult detection/energy-saving mode. The CPU 54 applies the base of the transistor 42 with a pulse drive voltage, whose repetition period and whose pulse width correspond to the drive frequency F_{des} and ON duty ratio D_{des}, respectively. As a result, the laser diode 32 oscillates in pulses with the drive frequency F_{des} and ON duty ratio D_{des}.

The CPU 54 judges in S8 whether or not the user manipulates the mode switch 49 to change the position of the mode switch 49. While the user does not manipulate the mode switch 49 (no in S8), the CPU 54 further judges in S9 whether or not the user turns off the power source 47. While the user does not turn off the power (no in S9), the program returns to S8. When the user turns off the power (yes in S9), the laser oscillating operation ends. In this way, the CPU 54 continues driving the laser diode 32 in the difficult detection/energy-saving mode until the user changes the position of the mode switch 49 or turns off the power.

When the user manipulates the mode switch 49 to further change the position of the mode switch 49 (S8: YES), then in S10, the CPU 54 sets the operation mode to the easy detection/normal mode. In S10, the CPU 54 reads, from the ROM 58, data combination of drive frequency Fₑₙ and ON duty ratio Dₑₙ that corresponds to the easy detection/normal mode. The CPU 54 applies the base of the transistor 42 with a pulse drive voltage, whose repetition period and whose pulse width correspond to the drive frequency Fₑₙ and ON duty ratio Dₑₙ, respectively. As a result, the laser diode 32 oscillates in pulses with the drive frequency Fₑₙ and ON duty ratio Dₑₙ.

The CPU 54 judges in S12 whether or not the user manipulates the mode switch 49 to change the position of the mode switch 49. While the user does not manipulate the mode switch 49 (no in S12), the CPU 54 further judges in S13 whether or not the user turns off the power source 47. While the user does not turn off the power (no in S13), the program returns to S12, When the user turns off the power (yes in S13), the laser oscillating operation ends. In this way, the CPU 54 continues driving the laser diode 32 in the easy detection/normal mode until the user changes the position of the mode switch 49 or turns off the power.

When the user manipulates the mode switch 49 to further change the position of the mode switch 49 (S12: YES), then in S14, the CPU 54 sets the operation mode to the easy detection/energy-saving mode. In S14, the CPU 54 reads, from the ROM 58, data combination of drive frequency Fₑₑₛ and ON duty ratio Dₑₑₛ that corresponds to the easy detection/energy-saving mode. The CPU 54 applies the base of the transistor 42 with a pulse drive voltage, whose repetition period and whose pulse width correspond to the drive frequency Fₑₑₛ and ON duty ratio Dₑₑₛ, respectively. As a result, the laser diode 32 oscillates in pulses with the drive frequency Fₑₑₛ and ON duty ratio Dₑₑₛ.

The CPU 54 judges in S16 whether or not the user manipulates the mode switch 49 to change the position of the mode switch 49. While the user does not manipulate the mode switch 49 (no in S16), the CPU 54 further judges in S17 whether or not the user turns off the power source 47. While the user does not turn off the power (no in S17), the program returns to S16. When the user turns off the power (yes in S17), the laser oscillating operation ends. In this way, the CPU 54 continues driving the laser diode 32 in the easy detection/energy-saving mode until the user changes the position of the mode switch 49 or turns off the power.

When the user manipulates the mode switch 49 to further change the position of the mode switch 49 (S16: YES), then in S18, the CPU 54 sets the operation mode to the photodetector mode. In S18, the CPU 54 reads, from the ROM 58, data combination of drive frequency Fₚ and ON duty ratio Dₚ that corresponds to the photodetector mode. The CPU 54 applies the base of the transistor 42 with a pulse drive voltage, whose repetition period and whose pulse width correspond to the drive frequency Fₚ and ON duty ratio Dₚ, respectively. As a result, the laser diode 32 oscillates in pulses with the drive frequency Fₚ and ON duty ratio Dₚ.

The CPU 54 judges in S20 whether or not the user manipulates the mode switch 49 to change the position of the mode switch 49. While the user does not manipulate the mode switch 49 (no in S20), the CPU 54 further judges in S21 whether or not the user turns off the power source 47. While the user does not turn off the power (no in S21), the program returns to S20. When the user turns off the power (yes in S21), the laser oscillating operation ends. In this way, the CPU 54 continues driving the laser diode 32 in the photodetector mode until the user changes the position of the mode switch 49 or turns off the power.

When the user manipulates the mode switch 49 to further change the position of the mode switch 49 (S20: YES), then in S22 the CPU 54 determines whether the user turns off the power source 47. If the user does not turn off the power (S22: NO), then the CPU 54 returns to S2. However, when the user turns off the power (S22: YES), then the laser oscillating operation ends.

In this way, if the power source 47 is switched on with the mode switch 49 not being operated, the laser diode 32 is driven initially in the difficult detection/normal mode. Next, if the mode switch 49 is operated once, the laser diode 32 is driven in the difficult detection/energy-saving mode. As the mode switch 49 is operated thereafter, the mode is subsequently set to the easy detection/normal mode, the easy detection/energy-saving mode, the photodetector mode, and back to the difficult detection/normal mode. Hence, the light-emitting mode in which the laser diode 32 is driven changes in this order each time the mode switch 49 is operated.

By operating at least one of the variable resistors 45 and 46 while the laser diode 32 is being driven in the selected oscillating mode, the user can further adjust at least one of the oscillating frequency and ON duty ratio, at which the laser diode 32 is driven, to a desired value in order to improve visibility of the light, the energy-saving effect, or both.

Next, the drive frequency ranges RF_{d}, RFₑ, and RFₚ and the ON duty ratio ranges RD_{dn}, RD_{des}, RDₑₙ, RDₑₑₛ, and RDₚ for each of the operation modes described above will be described in greater detail.

The upper limit (35%) of the ON-duty-ratio-range RD_{des} for the difficult detection/energy-saving mode is equal to the lower limit (35%) of the ON-duty-ratio-range RD_{dn} for the difficult detection/normal mode. Laser oscillations in the energy-saving mode will be performed at a smaller electric current than in the normal mode, thereby conserving power.

Similarly, the upper limit (50%) of the ON-duty-ratio-range RDₑₑₛ for the easy detection/energy-saving mode is equal to the lower limit (50%) of the ON-duty-ratio-range RDₑₙ for the easy detection/normal mode. Laser oscillations in the energy-saving mode will be performed at a smaller electric current than in the normal mode, thereby conserving power.

The upper limits of the drive frequency range RFₑ for the easy detection mode and the drive frequency range RFₚ for the photodetector mode are equivalent to a maximum frequency Fmax at which the laser diode 32 can oscillate. In the preferred embodiment, the upper limits for the drive frequency ranges RFₑ and RFₚ are equivalent to 10 KHz since the laser diode 32 having a wavelength of 808 nm can oscillate at a maximum frequency Fmax of 10 KHz. If the maximum frequency Fmax at which the laser diode 32 having a wavelength of 808 nm can oscillate changes through improvements of the laser diode 32, then the upper limits of the drive frequency ranges RFₑ and RFₚ can be set equal to the improved maximum frequency Fmax.

The upper limit of the drive-frequency-range RF_{d} for the difficult detection modes is equivalent to the upper limit (100 Hz) of a critical fusion frequency range (CFFR; higher than or equal to 80 Hz and lower than or equal to 100 Hz) described later. The lower limit of the drive-frequency-range RF_{d} for the difficult detection modes is equivalent to a minimum drive frequency (4 Hz) at which the Broca-Sulzer effect can be achieved.

The lower limit of the drive-frequency-range RFₑ for the easy detection modes is equivalent to the lower limit (80 Hz) of the CFFR The lower limit of the drive-frequency-range RFₚ for the photodetector mode is set equivalent to 1 KHz that is sufficiently higher than the frequency of a common fluorescent lamp, which is 50 or 60 Hz, for example.

The human retina can detect flicker in pulsating light having a low frequency. However, if the frequency of the pulses is greater than the critical fusion frequency (CFF), the flicker appears to the human retina to fuse together and to have a uniform brightness, as continuous light. While the value of the CFF varies according to the individual and cannot be set to a fixed value, the critical fusion frequency (CFF) falls in a range of about 80-100 Hz (higher than or equal to 80 Hz and lower than or equal to 100 Hz), referred to as the critical fusion frequency range (CFFR).

If the ON duty ratio and absolute intensity of light flashing at a frequency greater than CFF are D and I respectively, then an apparent brightness I′ of the pulsed light can be expressed by I′=I·D according to Talbot's Law. Since D is less than one, I′<I. Assuming that a laser diode is driven by some voltage to flash light at a frequency greater than CFF and that the same laser diode is continuously driven by the same voltage, the flashing light appears darker than the continuously oscillating light.

However, if the frequency, ON duty ratio, and absolute intensity of light flashing at a frequency smaller than CFF are F, D, and I, then the apparent brightness I′ of the pulsed light grows larger as the ON interval τ of the flashing light ((1/F)·D) increases and eventually reaches its peak at a value that is larger than the apparent brightness of the continuous light that has the same absolute intensity I (Broca-Sulzer effect). When the ON interval τ increases further, the apparent brightness I′ then begins to grow smaller until eventually stabilizing at a brightness equivalent to the apparent brightness of the continuous light having the absolute intensity I.

Here, the ratio of the apparent brightness I′ at the peak to the absolute brightness I (I′/I) is defined as an index k in the Broca-Sulzer effect. As disclosed by Mitsuo Ikeda (“Psychological Physics of Visual Sense”, p.167, 1975), it is known that the ON interval τ at the peak and the index k in the Broca-Sulzer effect vary dependently on the magnitude of the absolute intensity I as shown in the following Table 1.

TABLE 1

| I (td) | k | τ(s) |
|---|---|---|
| 200 | 5.5 | 0.03 |
| 160 | 4.9 | 0.04 |
| 55 | 2.0 | 0.062 |
| 26 | 1.9 | 0.1 |
| 4 | 1.2 | 0.125 |

According to Table 1, when the absolute brightness I equals 200 td (troland), for example, the apparent intensity I′ peaks when the continuous time τ equals 0.03 s (seconds) and is 5.5 times brighter than the apparent brightness of the continuous light at the absolute intensity I.

We can see from Table 1 that the index k of the Broca-Sulzer effect gradually drops as the ON interval T increases from 0.03 s to 0.125 s. This tells us that by setting the ON interval for each cycle of the flashing light to about 0.125 s or less, the value for k becomes about 1 or greater, indicating that the apparent brightness is greater than the apparent brightness of continuous light.

If the duty ratio D is 50%, the continuous times τ of 0.03 s, 0.04 s, 0.062 s, 0.1 s, and 0.125 s correspond to the pulsed frequencies F of 16.5 Hz, 12.5 Hz, 8.0 Hz, 5.0 Hz, and 4.0 Hz, respectively. Accordingly, by driving the laser diode 32 at a combination of a drive frequency of 4 Hz or greater and an ON duty ratio of 50% or less, it is possible to achieve a higher apparent brightness than the apparent brightness of continuous light.

The present inventor conducted tests in which the duty ratio was increased from 50% to 70%, while driving the laser diode 32 at a frequency of 4 Hz. It was confirmed that even when the duty ratio was changed from 50% to 70%, the apparent brightness still became greater than the apparent brightness of continuous light similarly to the case where the duty ratio was set to 50%. It was therefore confirmed that when the laser diode 32 is driven at 4 Hz, even when the duty ratio is changed from 50% to 70%, it is still possible to achieve a higher apparent brightness than the apparent brightness of continuous light.

The present inventor also studied the degree of visibility for a line beam generated when driving the laser light source module 3 under various combinations of drive frequency and ON duty ratio. In this experiment, the inventor used the drive frequencies 10 Hz, 20 Hz, 40 Hz, 60 Hz, 80 Hz, 100 Hz, 200 Hz, 400 Hz, 600 Hz, 800 Hz, 1 KHz, 2 KHz, 4 KHz, 6 KHz, 8 KHz, and 10 KHz and the ON duty ratios 1%, 10%, 20%, 30%, 40%, 50%, 60%, 70%, 80%, 90%, and 100%. FIG. 4(b) shows the results of these experiments. Numbers are employed in FIG. 4(b) to quantify the degree at which the line beam is visible, with a larger number indicating a greater degree of visibility. A “1” indicates that the line beam could not be detected visually at all, A “2” indicates that the line beam was difficult to detect visually. And “3-6” indicates the range in which visual detection was possible.

As can be seen in FIG. 4(b), the line beam is substantially visible when the drive frequency is within the drive-frequency-range RFe (from 80 Hz to 10 kHz) and the ON duty ratio is within the ON-duty-ratio-range RDₑₙ (50-100%) or within the ON-duty-ratio-range RDₑₑₛ (20-50%). The line beam is more visible when the drive frequency is within the drive-frequency-range RF_{d} (4-100 Hz) and the ON duty ratio is within. the ON-duty-ratio-range RD_{dn} (35-70%) or within the ON-duty-ratio-range RD_{des} (20-35%). The line beam can be detected visually also when the drive frequency is within the drive-frequency-range RFₚ (1-10 kHz) and the ON duty ratio is within the ON-duty-ratio-range RDₚ (30-100%).

FIG. 4(b) shows that it is possible to adjust both the degree of visibility and the degree of power consumption by selecting a combination of a drive frequency and an ON duty ratio. Since the degree of visibility varies according to the individual, in the preferred embodiment the manufacturer of the laser marking apparatus 1 performs tests prior to shipping the laser marking apparatus 1 using combinations of drive frequencies and ON duty ratios within the difficult detection/drive-frequency-range RF_{d} and the difficult detection/normal ON-duty-ratio-range RD_{dn}, the difficult detection/drive-frequency-range RF_{d} and the difficult detection/energy-saving ON-duty-ratio-range RD_{des}, the easy detection/drive-frequency-range RFₑ and the easy detection/normal ON-duty-ratio-range RDₑₙ, and the easy detection/drive-frequency-range RFₑ and the easy detection/energy-saving ON-duty-ratio-range RDₑₑₛ. The manufacturer selects the value combination among each range combination that achieves the best visibility, sets these values as (F_{dn}, D_{dn}) , (F_{des}, D_{des}), (Fₑₙ, Dₑₙ), and (Fₑₑₛ, Dₑₑₛ) and stores these values in the ROM 58. Further, the manufacturer selects the value combination at which the photodetector achieves the greatest accuracy from among combinations of drive frequencies in the photodetector-mode drive-frequency-range RFₚ and ON duty ratios within the photodetector-mode ON-duty-ratio-range RDₚ. The selected combination is set as (Fₚ, Dₚ) and stored in the ROM 58. When using the laser marking apparatus 1, the user can fine-tune at least one of the variable resistors 45 and 46 after setting his/her desired mode in S2, S6, S10, S14, or S18. Hence, the user can adjust the combination of the drive frequency and ON duty ratio values to optimal values based on: the user's visual sensitivity or the sensitivity of the photodetector; a desired level of power consumption; or both.

The laser light source module 3 in the preferred embodiment is a green laser. The human eye has a higher visual sensitivity for green than for other colors. For example, the human eye has as about five times as higher visual sensitivity for green than for red. Hence, a green laser is easier to discern than a laser of another color. However, green lasers have a greater current consumption than normal red lasers due to the low rate of incidence of the basic laser on the SHG crystal. For example, a basic laser output of 100 mW or greater is required to obtain a green light of 10 mw. However, by selecting an energy-saving mode, current consumption can be reduced considerably.

Green lasers are also easily influenced by temperature, failing to emit light in certain low-temperature and high-temperature ranges. This is because the wavelength of a basic laser changes about 0.2 nm per 1° C. If the wavelength changes ±2-3 nm from 808 nm, it is not possible to convert the wavelength with the SHG crystal. This is particularly a problem in high-temperature environments where the internal temperature of the laser diode rises due to heat generated by the basic laser itself in addition to the effects of the ambient temperature. As a result, the wavelength changes too much to be converted. However, by lowering the ON duty ratio, it is possible to reduce the percentage of time in which current is supplied to the laser diode 32 and to increase the percentage of time in which current is not supplied, thereby producing a stable green light even in high temperatures because heat dissipation occurring when current is stopped more than compensates for the rise in temperature caused by self-heating.

The present inventor also oscillated the laser light source module 3 at an ON duty ratio of 100%, that is, continuously When placed in an atmosphere of 20° C., the laser light source module 3 outputted 10 mW. When the laser light source module 3 was moved to an atmosphere of 40° C. without changing any of the other conditions, the output dropped about 3%.

The inventor then oscillated the laser light source module 3 in pulses at a frequency of 10 kHz and an ON duty ratio of 40%. The laser light source module 3 was first placed in the 20° C. atmosphere and subsequently moved to the 40° C. atmosphere. The laser light source module 3 achieved a stable output under the 40° C. atmosphere at 100% the output obtained under the 20° C. atmosphere.

Next, the inventor changed the oscillating frequency to 40 Hz, while maintaining the ON duty ratio at 40%, and disposed the laser light source module 3 first in a 20° C. atmosphere and next in a 40° C. atmosphere. Again, the laser light source module 3 achieved a stable output under the 40° C. atmosphere at 100% the output obtained under the 20° C. atmosphere. Moreover, visibility of the light improved when changing the oscillating frequency from 10 kHz to 40 Hz.

As described above, according to the present embodiment, by simply changing the drive frequency and ON duty ratio, it is possible to produce a line beam suitable for the desired operating environment and the desired conditions. Accordingly, it is possible to provide a highly accurate laser marking apparatus at low cost.

It is noted that the manufacturer may not execute the drive tests, but may simply set the drive frequency F_{dn} to an arbitrary value within the drive frequency range RF_{d}, set the ON duty ratio D_{dn} to an arbitrary value within the ON duty ratio range RD_{dn}, set the drive frequency F_{des} to an arbitrary value within the drive frequency range RF_{d}, set the ON duty ratio D_{des} to an arbitrary value within the ON duty ratio range RD_{des}, set the drive frequency Fₑₙ to an arbitrary value within the drive frequency range RFₑ, set the ON duty ratio Dₑₙ to an arbitrary value within the ON duty ratio range RDₑₙ, set the drive frequency Fₑₑₛ to an arbitrary value within the drive frequency range RFₑ, set the ON duty ratio Dₑₑₛ to an arbitrary value within the ON duty ratio range RDₑₑₛ, set the drive frequency Fₚ to an arbitrary value within the drive frequency range RFₚ, and set the ON duty ratio Dₚ to an arbitrary value within the ON duty ratio range RDₚ. It is still possible to set each value F_{dn}, D_{dn}, F_{des}, D_{des}, Fₑₙ, Dₑₙ, Fₑₑₛ, Dₑₑₛ, Fₚ, and Dₚ to such a value that is appropriate for a corresponding mode. When the user selects his/her desired mode, the corresponding value combination is selected. The user can manipulate the variable resistors 45 and 46 to adjust the value combination.

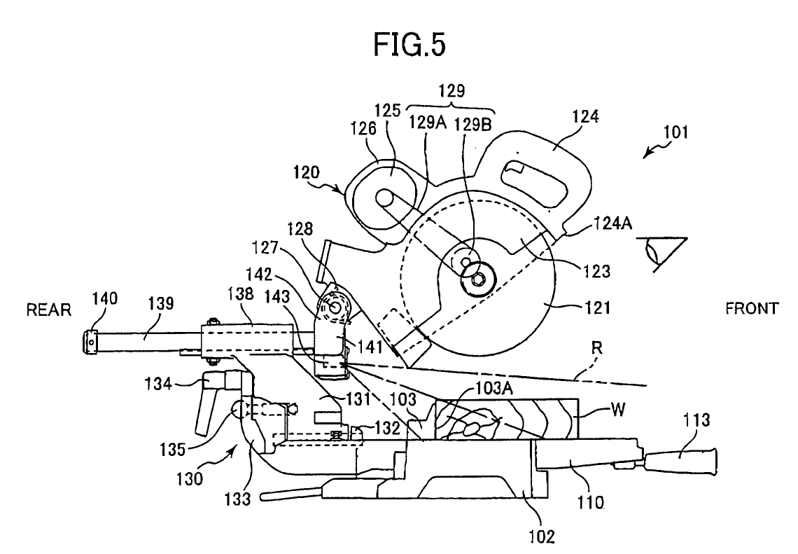

A miter saw according to a second embodiment of the present invention will be described with reference to FIGS. 5 to 9.

The miter saw 101 of the present embodiment is provided with the line beam optical system 2 of the first embodiment.

The miter saw 101 generally includes a base 102, a turntable 110, a cutting unit 120, and a support unit 130. The turntable 110 is rotatably mounted on the base 102. A workpiece W such as a wood or lumber is mounted on the base 102 and the turntable 110. The cutting unit 120 holds a circular saw blade 121. The support unit 130 extends from the turntable 110 for movably supporting the cutting unit 120 at a position above the turntable 110. The turntable 110 is embedded in the center part of the base 102 and is rotatable in a horizontal plane. An upper surface of the turntable 110 is flush with an upper surface of the base 102. The workpiece W can be placed on the upper surface of the base 102 and the turntable 110. A fence 103 extending along a diameter of the turntable 110 is secured to the upper surface of the base 102. The fence 103 has an abutment surface 103A on which the workpiece W is abuttable for setting the workpiece W at a desired position. The fence 103 is constituted by a pair of fence bodies each inner end being spaced away from each other for avoiding mechanical interference between the circular saw blade 121 and the fence 103.

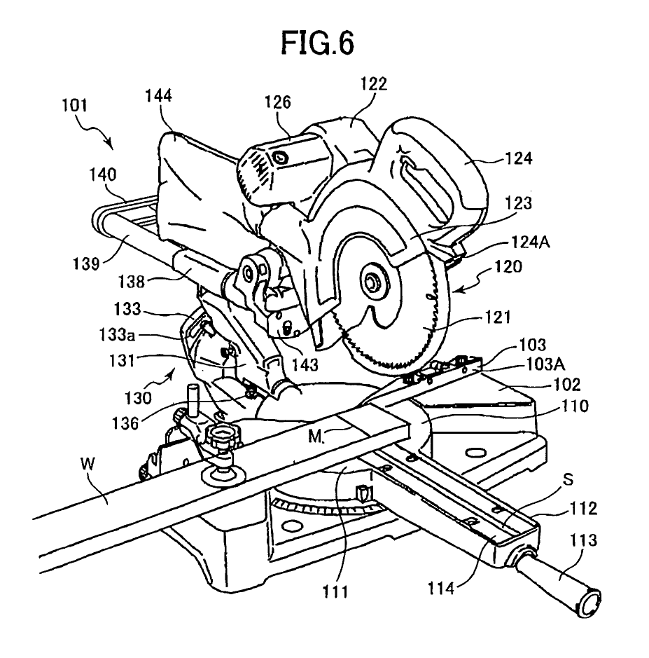

As shown in FIG. 6, the turntable 110 includes a disc shaped table section 111 and an operation section 112 extending forwards from the table section 111 in a diametrical direction thereof. A knob handle 113 is fastened to a front end of the operation section 112. A user can grip the knob handle 113 and move it sideways to rotate the table section 111 about its axis with respect to the base 102. A pair of blade guides 114 is secured partly on the upper surface of the table section 111 and partly on the upper surface of the operation section 112. The blade guides 114 extend parallel to each other and spaced apart from each other defining a slit S therebetween. The slit S extends in the diametrical direction of the table section 111 and allows the circular blade tip to be entered therein.

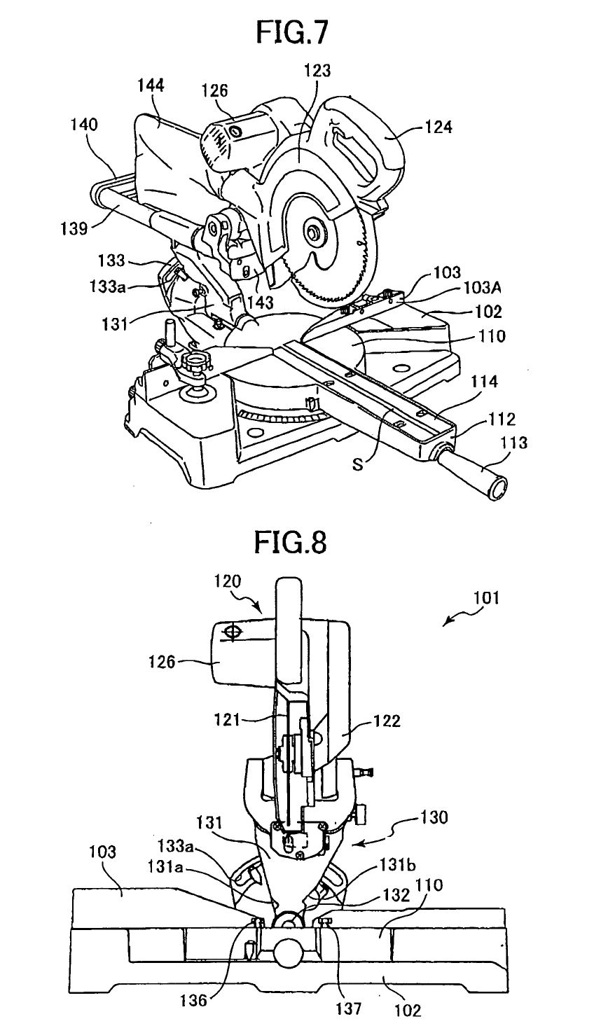

As shown in FIG. 7, rear ends of the blade guides 114, i.e., the rear end of the slit S, are closer to the support unit 130 than the abutment surfaces 103A of the fences 3 to the support unit 130. Therefore, the rear end of the slit S is always positioned in the gap between the inner ends of the fence bodies irrespective of the rotational direction and rotational amount of the turntable 110.

As shown in FIGS. 5 and 6, the support unit 130 generally includes a holder 131, a holder shaft 132, a bracket 133, a clamp lever 134, a pair of slide shafts 139, and a hinge 141 pivotally movably supporting the cutting unit 120. The holder 131 upstands from the rear end portion of the turntable 110 through the holder shaft 132. The holder shaft 132 is so positioned that its axis extends almost in the upper surface of the turntable 110. The holder 131 is pivotally movably supported about the holder shaft 132 so that the holder 131 is tiltable leftward or rightward toward the upper surface of the turntable 110. The bracket 133 upstands from the rear end of the turntable 110 at a position behind the holder 131. The bracket 133 is formed with an arcuate slot 133a whose center is coincident with the axis of the holder shaft 132. The clamp lever 134 has a shaft portion 135 (FIG. 5) which extends through the arcuate slot 133a. The clamp lever 134 is manipulated to change the fastening position of the shaft portion 135 to the holder 131. Thus, a leftward or rightward tilting angle of the holder 131 about the axis of the holder shaft 132 can be controlled. As shown in FIG. 8, the holder 131 has notches 131a and 131b in the lower-left and lower-right sides thereof. Further, adjustment screws 136 and 137 in threading engagement with the turntable 110 are provided at positions in abutting relation to the notches 131a and 131b, respectively. The adjustment screws 136 and 137 can be turned to change the heights of screw heads while the clamp lever 134 remains open so as to change abutment position between the notch 131a or 131b and the head of the screw 136 or 137. Thus, tilting angle of the holder 131 can be adjusted. Upon fixing the tilting angle of the holder 131 at a specific angle, the circular saw blade 121 is tilted at the same angle to perform so called “slant cutting”.

As shown in FIGS. 5 and 6, a tubular slide-shaft support 138 is provided integrally with the upper end of the holder 131 for slidably movably supporting a pair of slide shafts 139 in parallel to each other in the frontward/rearward direction. A stop member 140 straddles the rear end portions of the slide shafts 139 for regulating the frontmost position of the slide shafts 139. The hinge 141 has an intermediate position fixed to the front ends of the slide shafts 139. The hinge 141 has an upper end portion provided with a support section 142 for hingedly supporting the cutting unit 120, The hinge 141 has a lower portion provided with a laser casing 143 that mounts therein the line beam optical system 2 (FIG. 2) of the first embodiment.

As shown in FIG. 6, the cutting unit 120 has a gear case 122 for detachably and rotatably supporting the circular saw blade 121. The cutting unit 120 also includes a blade guard 123, a handle 124, and a motor housing 126 those formed integrally with the gear case 122. The gear case 122 holds a pivot shaft 127 rotatably supported to the support section 142 of the hinge 141. The blade guard 123 covers an upper half of the circular saw blade 121. The handle 124 is located at a front side of the blade guard 123. The motor housing 126 is provided at the rear side of the handle 124 and accommodates therein a motor 125. The pivot shaft 127 extends almost parallel to a rotation axis of the circular saw blade 121. Thus, the cutting unit 120 has a pivot axis extending substantially parallel to the axis of the blade 121. Thus, the cutting unit 120 is pivotally or swingably supported to the support unit 130 through the pivot shaft 127. The motor housing 126 can be positioned at the top of the blade guard 123 when the gear case 122 lowers to the workpiece W so that the blade 121 can cut the workpiece W. A torsion spring 128 is wound around the pivot shaft 127 and is interposed between the gear case 122 and the hinge 141 for biasing the gear case 122 upwardly. The gear case 122 accommodates therein a transmission mechanism 129 including an endless belt 129A and a pulley 129B for transmitting rotation of the motor 125 to the circular saw blade 121. A dust bag 144 is removably fastened to the blade guard 123 and communicates with the space between the gear case 122 and the blade guard 123 for collecting cutting chips into the dust bag 144.

With the above-described structure, the turntable 110 is rotated to such a rotational position that a laser line beam R from the line beam optical system 2 in the laser casing 143 will be in alignment with a cutting line marker M which is drawn on the upper surface of the workpiece W. The user can visually position the circular saw blade 121 on the cutting line marker M. This ensures that the workpiece W will be cut along the cutting line marker M accurately.

According to the present embodiment, the ROM 58 stores data of four combinations of drive frequencies and ON duty ratios (F_{dn}, D_{dn}) , (F_{des}, D_{des}), (Fₑₙ, Dₑₙ) (Fₑₑₛ, Dₑₑₛ) in correspondence with four modes (a difficult detection/normal mode, a difficult detection/energy-saving mode, an easy detection/normal mode, and an easy detection/energy-saving mode), but excluding the photodetector mode. The pulse oscillating circuit 4 executes the processes of S0-S22 in FIG. 4(a), excluding S18, S20, and S21. The user selects one of the four modes based on the operating environment and whether power conservation is necessary. The laser diode 32 is driven according to a combination of drive frequency and ON duty ratio values that is optimal for the selected mode.

Next, a variation of the miter saw 101 according to the preferred embodiment will be described.

In this variation, the ROM 58 stores a combination of one drive frequency and one ON duty ratio in correspondence with a flashing mode and data for an ON duty ratio of 100% in correspondence with a continuous mode. In this example, the drive frequency and ON duty ratio for the flashing mode are equal to the drive frequency F_{dn} and the ON duty ratio D_{dn} described in the first embodiment.

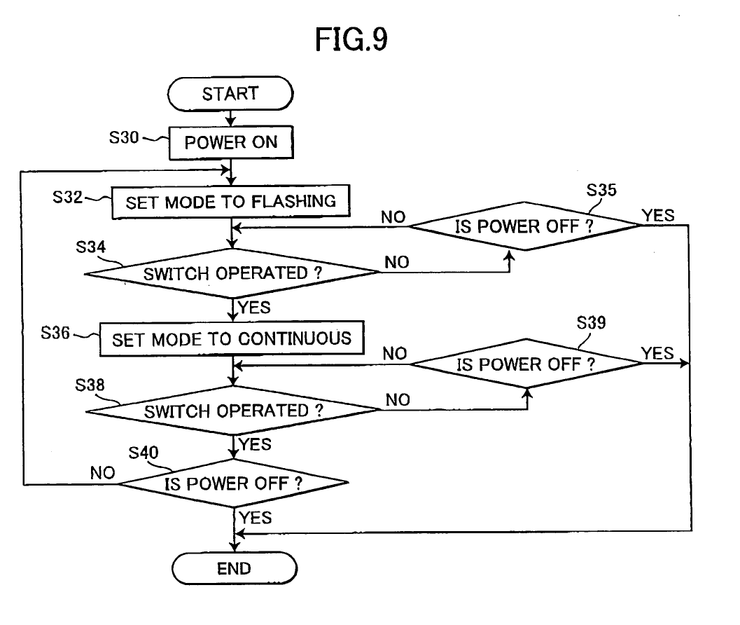

In the present variation, the pulse oscillating circuit 4 executes the laser oscillating operation shown in FIG. 9.

When the power source 47 is switched on in S30, the CPU 54 initializes the operation mode to the flashing mode in S32. In S32, the CPU 54 reads, from the ROM 58, data combination of drive frequency F_{dn} and ON duty ratio D_{dn} that corresponds to the flashing mode. The CPU 54 applies the base of the transistor 42 with a pulse drive voltage, whose repetition period and whose pulse width correspond to the drive frequency F_{dn} and ON duty ratio D_{dn}, respectively. As a result, the laser diode 32 oscillates in pulses with the drive frequency F_{dn} and ON duty ratio D_{dn}.

The CPU 54 judges in S34 whether or not the user manipulates the mode switch 49 to change the position of the mode switch 49. While the user does not manipulate the mode switch 49 (no in S34), the CPU 54 further judges in S35 whether or not the user turns off the power source 47. While the user does not turn off the power (no in S35), the program returns to S34. When the user turns off the power (yes in S35), the laser oscillating operation ends. In this way, the CPU 54 continues driving the laser diode 32 in the flashing mode until the user changes the position of the mode switch 49 or turns off the power.

If the user changes the position of the mode switch 49 (S34: YES), then in S36, the CPU 54 sets the operation mode to the continuous mode. In S36, the CPU 54 reads, from the ROM 58, data of ON duty ratio of 100% that corresponds to the continuous mode. The CPU 54 applies the base of the transistor 42 with a drive voltage continuously. As a result, the laser diode 32 oscillates continuously.

The CPU 54 judges in S38 whether or not the user manipulates the mode switch 49 to change the position of the mode switch 49. While the user does not manipulate the mode switch 49 (no in S38), the CPU 54 further judges in S39 whether or not the user turns off the power source 47. While the user does not turn off the power (no in S39), the program returns to S38. When the user turns off the power (yes in S39), the laser oscillating operation ends. In this way, the CPU 54 continues driving the laser diode 32 in the continuous mode until the user changes the position of the mode switch 49 or turns off the power.

If the user changes the position of the mode switch 49 (S38: YES), then in S40 the CPU 54 determines whether the user turns off the power source 47. If the user does not turn off the power (S40: NO), then the CPU 54 returns to S32. However, if the user turns off the power (S40: YES), then the laser oscillating operation ends.

According to the present variation, light suitable for the surroundings can be generated by selecting either pulsed light or continuous light. For example, in a bright area or other environment difficult to visually detect a marking light, a laser light R can be made more visible by controlling the laser diode 32 to emit a flashing light, thereby facilitating cutting work along a cutting line marker.

In the above description, the holder 131 is supported on the turntable 110 to be rotatable or tiltable with respect to the turntable 110. However, the holder 131 may be supported on the base 102 rotatable or tiltable with respect to the base 102. In this case, the bracket 133 is mounted on the base 102.

The holder 131 may be fixedly secured to the turntable 110 or the base 102. The slide shafts 139 may be omitted from the support unit 130, but the hinge 141 may be directly and fixedly secured to the holder 131.

The laser casing 143 may be provided to the cutting unit 120 instead to the holder 131. In this case, the laser casing 143 may be provided to the front end 124A of the handle 124 (FIGS. 5 and 6).

In the above description, the line beam optical system 2 is mounted in the laser case 143. However, neither the rod lens 6 nor the collimator lens 5 need be mounted in the laser case 143, Only the laser light source module 3 and the pulse oscillating circuit 4 may be mounted in the laser case 143. Or, only the laser light source module 3 may be mounted in the laser case 143, but the pulse oscillating circuit 4 may be provided on the miter saw 101 at a position different from the laser case 143.

While the invention has been described in detail with is reference to the specific embodiments thereof, it would be apparent to those skilled in the art that various changes and modifications may be made therein without departing from the spirit of the invention.

For example, the laser light source module 3 may be configured of a red laser. In this case, the laser diode 32 is configured of a laser diode having a wavelength of 635 nm, for example. It is not necessary to provide the laser light source module 3 with the wavelength converting optical element 34.

A mode for continuously irradiating a laser light may be added to the five modes in the first embodiment. In other words, as in the second embodiment, the ROM 58 may store data for an ON duty ratio of 100% in correspondence with a continuous mode. In this case, the processes of S36, S38, and S39 in FIG. 9 are added between S20 and S22 of FIG. 4(a).

The laser light source module 3 and pulse oscillating circuit 4 may also be accommodated in a pen light type cylindrical package or the like and used as a laser pointer. In this case, as with the miter saw 101 of the second embodiment, the pulse oscillating circuit 4 may perform the operations of S0-S22 in FIG. 4(a), excluding S18, S20, and S21, or may perform the operations shown in FIG. 9. The laser light source module 3 and pulse oscillating circuit 4 may be applied to other devices employing a light beam.

The line beam optical system 2 is not restricted to a laser marking apparatus or a miter saw, but may also be applied to a wide variety of other devices employing a line beam. The laser light source module 3 is not restricted to a line beam optical system, a laser marking apparatus, or a miter saw, but may also be applied to a wide variety of other devices employing a laser beam.

What is claimed is:

1. A laser light generator comprising:
a semiconductor laser that emits laser light;
a switching element that switches the semiconductor laser on and off;
a selecting unit that selects one of a plurality of operation modes; and
a controlling unit that controls the switching element to drive the semiconductor laser based on a combination of a drive frequency and an ON duty ratio that corresponds to the operation mode selected by the selecting unit.

2. A laser light generator according to claim 1, further comprising a storage unit that pre-stores a plurality of combinations of drive frequencies and ON duty ratios in one-to-one correspondence with the plurality of operation modes;
wherein the controlling unit reads, from the storage unit, one combination of the drive frequency and the ON duty ratio that corresponds to the selected mode, the controlling unit controlling the switching element to drive the semiconductor laser based on the read drive frequency and ON duty ratio.

3. A laser light generator according to claim 2, wherein the plurality of operation modes include a difficult detection/normal mode, a difficult detection/energy-saving mode, an easy detection/normal mode, and an easy detection/energy-saving mode;
the storage unit pre-stores, in correspondence with the difficult detection/normal mode, a combination of a drive frequency whose value is higher than or equal to 4 Hz and lower than or equal to 100 Hz and an ON duty ratio whose value is greater than or equal to 35% and smaller than or equal to 70%;
the storage unit pre-stores, in correspondence with the difficult detection/energy-saving mode, a combination of a drive frequency whose value is higher than or equal to 4 Hz and lower than or equal to 100 Hz and an ON duty ratio whose value is greater than or equal to 20% and smaller than or equal to 35%;
the storage unit pre-stores, in correspondence with the easy detection/normal mode, a combination of a drive frequency whose value is higher than or equal to 80 Hz and lower than or equal to 10 KHz and an ON duty ratio whose value is greater than or equal to 50% and smaller than 100%; and
the storage unit pre-stores, in correspondence with the easy detection/energy-saving mode, a combination of a drive frequency whose value is higher than or equal to 80 Hz and lower than or equal to 10 KHz and an ON duty ratio whose value is greater than or equal to 20% and smaller than or equal to 50%.

4. A laser light generator according to claim 3, wherein the plurality of operation modes further include a photodetector mode; and
the storage unit pre-stores, in correspondence with the photodetector mode, a combination of a drive frequency whose value is higher than or equal to 1 KHz and lower than or equal to 10 KHz and an ON duty ratio whose value is greater than or equal to 30% and smaller than 100%.

5. A laser light generator according to claim 1, wherein the selecting unit includes an operating member enabling a user to selects his/her desired operation mode among the plurality of operation modes.

6. A laser light generator according to claim 5, wherein the controlling unit includes an adjusting member enabling the user to manually adjust at least one of the drive frequency and the ON duty ratio of the switching element.

7. A laser light generator according to claim 1, further comprising a wavelength converting element that converts the wavelength of the laser light outputted from the semiconductor laser to a wavelength of 532 nm.

8. A line beam optical system comprising:
a laser light generator including;
a semiconductor laser that emits laser light;
a switching element that switches the semiconductor laser on and off;
a selecting unit that selects one of a plurality of operation modes; and
a controlling unit that controls the switching element to drive the semiconductor laser based on a combination of a drive frequency and an ON duty ratio that corresponds to the operation mode selected by the selecting unit;
a collimator lens that converts the laser beam emitted from the laser light generator; and
a rod lens that converts the collimated light into a line beam.

9. A laser marking apparatus comprising:
a line beam optical system, including:
a laser light generator including:
a semiconductor laser that emits laser light;
a switching element that switches the semiconductor laser on and off;
a selecting unit that selects one of a plurality of operation modes; and
a controlling unit that controls the switching element to drive the semiconductor laser based on a combination of a drive frequency and an ON duty ratio that corresponds to the operation mode selected by the selecting unit;
a collimator lens that converts the laser beam emitted from the laser light generator; and
a rod lens that converts the collimated light into a line beam; and
a support mechanism that supports the line beam optical system.

10. A miter saw comprising:
a base on which a material to be cut is placed;
a support unit supported on the base;
a circular saw cutting unit pivotally supported by the support unit; and
a laser light generator that is disposed on either one of the support unit and the circular saw cutting unit and that irradiates laser light on the material to be cut, the laser light generator including:
a semiconductor laser that emits laser light;
a switching element that switches the semiconductor laser on and off;
a selecting unit that selects one of a plurality of operation modes; and
a controlling unit that controls the switching element to drive the semiconductor laser based on a combination of a drive frequency and an ON duty ratio that corresponds to the operation mode selected by the selecting unit.

11. A miter saw comprising:
a base on which a material to be cut is placed;
a support unit supported on the base;
a circular saw cutting unit pivotally supported by the support unit; and
a laser light generator that is disposed on either one of the support unit and the circular saw cutting unit and that irradiates laser light on the material to be cut, the laser light generator including:
a semiconductor laser that emits laser light;
a switching element that switches the semiconductor laser on and off;
a selecting unit that selects one of a flashing mode and a continuous mode; and
a controlling unit that controls the switching element to drive the semiconductor laser at a prescribed frequency when the flashing mode is selected by the selecting unit and that controls the switching element to drive the semiconductor laser to emit continuous light when the continuous mode is selected by the selecting unit.
